(19) United States
(12) Patent Application Publication
(10) Pub. No.: US 2007/0223578 A1
(43) Pub. Date: Sep. 27, 2007

(54) Motion Estimation and Segmentation for Video Data

(75) Inventor: Reinier Bernardus Maria Klein Gunnewiek, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN, NETHERLANDS (NL)

(21) Appl. No.: 10/599,437

(22) PCT Filed: Mar. 18, 2005
(86) PCT No.: PCT/IB05/50948

§ 371 Date: Sep. 28, 2006

(30) Foreign Application Priority Data
Mar. 31, 2004 (EP) 04101312.9

(51) Int. Cl. H04B 1/66

(52) U.S. Cl. 375/240.12

(57) ABSTRACT

In an encoder, an offset processor (307) generates picture elements with sub-pixel offsets for a picture element in a reference frame. A scan processor (309) searches a frame to find a matching picture element and a selection processor (311) selects the offset picture element resulting in the closest match. The first frame is encoded relative to the selected picture element, and displacement data comprising sub-pixel data indicative of the selected offset picture element and integer pixel displacement data indicating an integer pixel offset between the first picture element and the matching picture element is included the video data. A video decoder extracts the first picture element from a reference frame and generates an offset picture element in response to the sub-pixel information by interpolation in the reference frame. A predicted frame is decoded by shifting the offset frame in response to the integer pixel information. The invention allows encoding with shift motion estimation and segment based motion compensation with sub-pixel accuracy.

The invention relates to a system of video encoding and decoding and in particular a video encoder and decoder using shift motion estimation.

In recent years, the use of digital storage and distribution of video signals have become increasingly prevalent. In order to reduce the bandwidth required to transmit digital video signals, it is well known to use efficient digital video encoding comprising video data compression whereby the data rate of a digital video signal may be substantially reduced.

In order to ensure interoperability, video encoding standards have played a key role in facilitating the adoption of digital video in many professional- and consumer applications. Most influential standards are traditionally developed by either the International Telecommunications Union (ITU-T) or the MPEG (Motion Pictures Experts Group) committee of the ISO/IEC (the International Organization for Standardization/the International Electrotechnical Committee). The ITU-T standards, known as recommendations, are typically aimed at real-time communications (e.g. videoconferencing), while most MPEG standards are optimized for storage (e.g. for Digital Versatile Disc (DVD)) and broadcast (e.g. for Digital Video Broadcast (DVB) standard).

Currently, one of the most widely used video compression techniques is known as the MPEG-2 (Motion Picture Expert Group) standard. MPEG-2 is a block based compression scheme wherein a frame is divided into a plurality of blocks each comprising eight vertical and eight horizontal pixels. For compression of luminance data, each block is individually compressed using a Discrete Cosine Transform (DCT) followed by quantization which reduces a significant number of the transformed data values to zero. Frames based only on intra-frame compression are known as Intra Frames (1-Frames).

In addition to intra-frame compression, MPEG-2 uses inter-frame compression to further reduce the data rate. Inter-frame compression includes generation of predicted frames (P-frames) based on previous I-frames. In addition, I and P frames are typically interposed by Bidirectional predicted frames (B-frames), wherein compression is achieved by only transmitting the differences between the B-frame and surrounding I- and P-frames. In addition, MPEG-2 uses motion estimation wherein the image of macro-blocks of one frame found in subsequent frames at different positions are communicated simply by use of a motion vector. Motion estimation data generally refers to data which is employed during the process of motion estimation. Motion estimation is performed to determine the parameters for the process of motion compensation or, equivalently, inter prediction.

As a result of these compression techniques, video signals of standard TV studio broadcast quality level can be transmitted at data rates of around 2-4 Mbps.

Recently, a new ITU-T standard, known as H.26L, has emerged. H.26L is becoming broadly recognized for its superior coding efficiency in comparison to the existing standards such as MPEG-2. Although the gain of H.26L generally decreases in proportion to the picture size, the potential for its deployment in a broad range of applications is undoubted. This potential has been recognized through formation of the Joint Video Team (JVT) forum, which is responsible for finalizing H.26L as a new joint ITU-T/MPEG standard. The new standard is known as H.264 or MPEG-4 AVC (Advanced Video Coding). Furthermore, H.264-based solutions are being considered in other standardization bodies, such as the DVB and DVD Forums.

The H.264/AVC standard employs similar principles of block-based motion estimation as MPEG-2. However, H.264/AVC allows a much increased choice of encoding parameters. For example, it allows a more elaborate partitioning and manipulation of 16×16 macro-blocks whereby e.g. a motion compensation process can be performed on divisions of a macro-block as small as 4×4 in size. Another, and even more efficient extension, is the possibility of using variable block sizes for prediction of a macro-block. Accordingly, a macro-block (still 16×16 pixels) may be partitioned into a number of smaller blocks and each of these sub-blocks can be predicted separately. Hence, different sub-blocks can have different motion vectors and can be retrieved from different reference pictures. Also, the selection process for motion compensated prediction of a sample block may involve a number of stored, previously-decoded frames (or images), instead of only the adjacent frames (or images). Also, the resulting prediction error following motion compensation may be transformed and quantized based on a 4×4 block size, instead of the traditional 8×8 size.

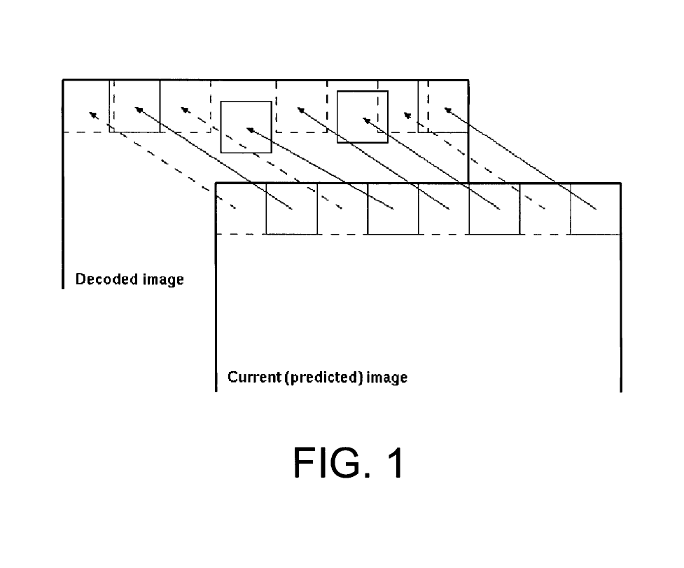

Generally, existing encoding standards such as MPEG 2 and H.264/AVC use a fetch motion estimation technique as illustrated in FIG. 1. In fetch motion estimation, a first block of the frame to be encoded (the predicted frame) is scanned across a reference frame and compared to the blocks of the reference frame. The difference between the first block and the blocks of the reference frame is determined, and if a given criterion is met for one of the reference frame blocks, this is used for as a basis for motion compensation in the predicted frame. Specifically, the reference frame block may be subtracted from the predicted frame block with only the resulting difference being encoded. In addition, a motion estimation vector pointing to the reference frame block from the predicted frame block is generated and included in the encoded data stream. The process is consequently repeated for all blocks in the predicted frame. Thus, for each block of the predicted frame, the reference frame is scanned for a suitable match. If one is found, a motion vector is generated and attached to the predicted frame block.

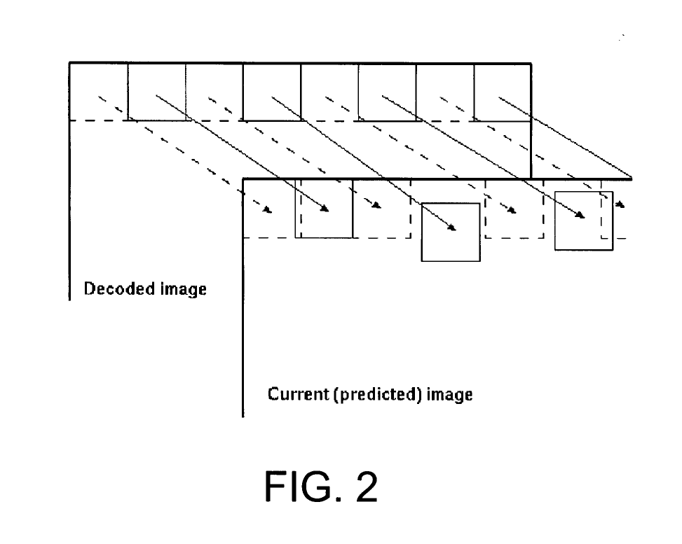

An alternative motion estimation technique is known as shift motion estimation and is illustrated in FIG. 2. In shift motion estimation, a block of the reference frame is scanned across the frame to be encoded (the predicted frame) and compared to the blocks of this frame. The difference between the block and the blocks of the predicted frame is determined and if a given criterion is met for one of the predicted frame blocks, the reference frame block is used as a basis for motion compensation of that block in the predicted frame. Specifically, the reference frame block may be subtracted from the predicted frame block with only the resulting difference being encoded. In addition, a motion estimation vector pointing to the predicted frame block from the reference frame block is generated and included in the encoded data stream. The process is consequently repeated for all blocks in the reference frame. Thus, for each block of the reference frame, the predicted frame is scanned for a suitable match. If one is found, a motion vector is generated and attached to the reference frame block.

Thus, as illustrated in FIGS. 1 and 2, in fetch motion estimation the blocks of the predicted frame are sequentially compared to the reference frame, and motion vectors are attached to the predicted frame blocks if a suitable match is found, whereas in shift motion estimation the blocks of the reference frame are sequentially compared to the predicted frame and motion vectors are attached to the reference frame blocks if a suitable match is found

Fetch motion estimation is typically preferred to shift motion estimation as shift motion estimation has some associated disadvantages. In particular, shift motion estimation does not systematically process all blocks of the predicted frame and therefore results in overlaps and gaps between motion estimation regions. This tends to result in a reduced quality to data rate ratio.

However, in some applications it is desirable to use shift motion estimation and in particular in applications wherein a predictable motion estimation block structure is not present shift motion estimation is preferable.

Hence, an improved system for video encoding and decoding would be advantageous and in particular a system enabling or facilitating the use of shift motion estimation, improving the quality to data rate ratio and/or reducing complexity would be advantageous.

Accordingly, the Invention preferably seeks to mitigate, alleviate or eliminate one or more of the above mentioned disadvantages singly or in any combination.

According to a first aspect of the invention, there is provided a video encoder for encoding a video signal to generate video data; the video encoder comprising: means for generating, for at least a first picture element in a reference frame, a plurality of offset picture elements having different sub-pixel offsets; means for searching, for each of the plurality of offset picture elements, a first frame to find a matching picture element; means for selecting a first offset picture element of the plurality of offset picture elements; means for generating displacement data for the first picture element, the displacement data comprising sub-pixel displacement data indicative of the first offset picture element and integer pixel displacement data indicating an integer pixel offset between the first picture element and the matching picture element; means for encoding the matching picture element relative to the selected offset picture element; and means for including the displacement data in the video data.

The first picture element may be any suitable group or set of pixels but is preferably a contiguous pixel region. The invention may provide an advantageous means for sub-pixel displacement of picture elements. By separating the integer and sub-integer displacement data, improved encoding performance may be achieved. Furthermore, the invention may provide for a practical and high performance determination of sub-pixel displacement data. The displacement data is referenced to a first picture element of the reference frame thereby providing displacement data which may be used for a matching picture element in a first frame without requiring the first frame to be encoded or the second picture element to be determined in advance. Hence, a feed forward displacement of picture elements is enabled or facilitated.

Preferably, the means for selecting comprises means for determining a difference parameter between each of the plurality of offset picture elements and the matching picture element and means for selecting the first offset picture element as the offset picture element having the smallest difference parameter. For example, a difference parameter corresponding to the mean square sum of pixel differences between an offset picture element and the matching picture element may be determined and the first offset picture element may be chosen as the one having the smallest mean square sum. This provides a simple yet effective means of determining a matching picture element.

Preferably, the video encoder further comprises means for generating the first picture element by image segmentation of the reference frame. This provides a suitable way of determining suitable picture elements. Thus, the invention may provide a low complexity and high performance means of generating sub-pixel accuracy for displacement of segments between frames which can be used for displacement of segments without requiring knowledge of the location of segments in the first frame into which the segments are displaced.

Preferably, the video encoder is configured not to include segment dimension data in the video data. The invention allows for the effective generation of video data that allows for sub-pixel displacement of segments without requiring the information of the segment dimension to be included in the video data itself. This may reduce the video data size significantly thus reducing the communication bandwidth required for transmission of the video data. The segmentation may be determined independently in a video decoder and based on the displacement data, a segment may be displaced in the first frame without requiring this to be decoded first. In particular, this allows sub-pixel segment displacement to be part of the decoding of the first frame.

Preferably, the video encoder is a block based video encoder and the first picture element is an encoding block. In particular, the video encoder may utilise Discrete Fourier Transform (DCT) block processing and the first picture element may correspond to a DCT block. This facilitates implementation and reduces the required processing resource.

Preferably, the means for generating the plurality of offset picture elements is operable to generate at least one offset picture element by pixel interpolation. This provides a simple and suitable means for generating the plurality of offset picture elements.

Preferably, the displacement data is motion estimation data and in particular the displacement data is shift motion estimation data. Hence, the invention provides an advantageous means for generating video data using shift motion estimation. An improved quality to data size ratio may be achieved while retaining the advantages of shift motion estimation.

According to a second aspect of the invention, there is provided a video decoder for decoding a video signal, the video decoder comprising: means for receiving the video signal comprising at least a reference and a predicted frame and displacement data for a plurality of picture elements of the reference frame; means for determining a first picture element of the plurality of picture elements of the reference frame; means for extracting displacement data for the first picture element comprising first sub-pixel displacement data and first integer pixel displacement data; means for generating a sub-pixel offset picture element by offsetting the first picture element in response to the first sub-pixel displacement data; means for determining a location of a second picture element in the predicted frame in response to a location of the first picture element in the first image and the first integer pixel displacement data; and means for decoding the second picture element in response to the sub-pixel offset picture element.

It will be appreciated that the features, variants, options and refinements discussed with reference to the video encoder are equally applicable to the video decoder as appropriate. In particular, the means for determining a first picture element is operable to determine the first picture element by image segmentation of the first frame. Also, the displacement data may be sub-pixel accuracy shift motion estimation data used for segment based motion compensation.

Similarly, it will be appreciated that the advantages discussed with reference to the video encoder are equally applicable to the video decoder as appropriate. Thus, the video decoder allows decoding of a shift motion estimation encoded signal having an improved quality to data size ratio.

According to a third aspect of the invention, there is provided method of encoding a video signal to generate video data; the method comprising the steps of: generating, for at least a first picture element in a reference frame, a plurality of offset picture elements having different sub-pixel offsets; searching, for each of the plurality of offset picture elements, a first frame to find a matching picture element; selecting a first offset picture element of the plurality of offset picture elements; generating displacement data for the first picture element, the displacement data comprising sub-pixel displacement data indicative of the first offset picture element and integer pixel displacement data indicating an integer pixel offset between the first picture element and the matching picture element; encoding the matching picture element relative to the selected offset picture element; and including the displacement data in the video data.

According to a fourth aspect of the invention, there is provided a method of decoding a video signal, the method comprising the steps of: receiving the video signal comprising at least a reference and a predicted frame and displacement data for a plurality of picture elements of the reference frame; determining a first picture element of the plurality of picture elements of the reference frame; extracting displacement data for the first picture element comprising first sub-pixel displacement data and first integer pixel displacement data; generating a sub-pixel offset picture element by offsetting the first picture element in response to the first sub-pixel displacement data; determining a location of a second picture element in the predicted frame in response to a location of the first picture element in the first image and the first integer pixel displacement data; and decoding the second picture element in response to the sub-pixel offset picture element.

These and other aspects, features and advantages of the invention will be apparent from and elucidated with reference to the embodiment(s) described hereinafter.

An embodiment of the invention will be described, by way of example only, with reference to the drawings, in which

FIG. 1 is an illustration of fetch motion estimation in accordance with prior art;

FIG. 2 is an illustration of shift motion estimation in accordance with prior art;

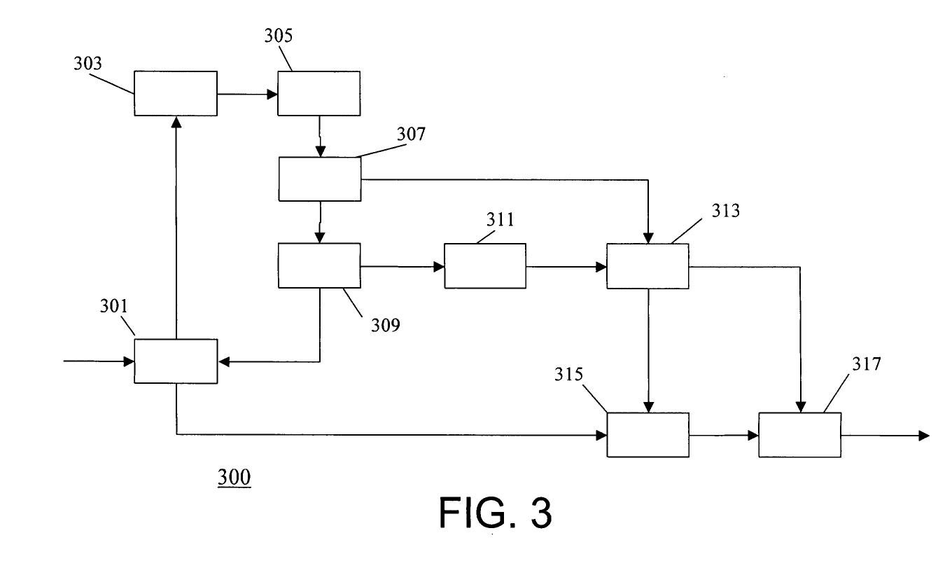

FIG. 3 is an illustration of shift motion estimation video encoder in accordance with an embodiment of the invention; and

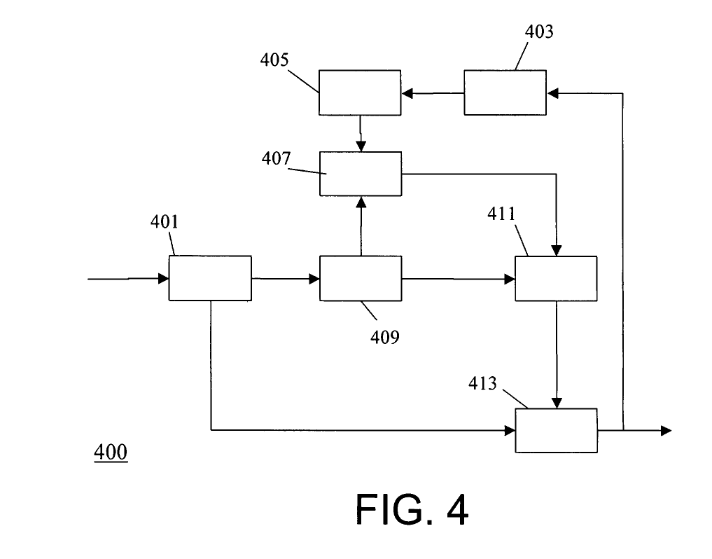

FIG. 4 is an illustration of shift motion estimation video decoder in accordance with an embodiment of the invention.

The following description focuses on an embodiment of the invention applicable to a video encoding system using segment based shift motion estimation and compensation. However, it will be appreciated that the invention is not limited to this application.

FIG. 3 is an illustration of shift motion estimation video encoder in accordance an embodiment of the invention. The operation of the video encoder will be described in the specific situation where a first frame is encoded using motion estimation and compensation from a single reference frame but it will be appreciated that in other embodiments motion estimation for one frame may be based on any suitable frame or frames including for example future frame(s) and/or frame(s) having different temporal offsets from the first frame.

The video encoder comprises a first frame buffer 301 which stores a frame to be encoded henceforth denoted the first frame. The first frame buffer 301 is coupled to a reference frame buffer 303 which stores a reference frame used for shift motion estimation encoding of the first frame. In the specific example, the reference frame is simply a previous original frame which has been moved from the first frame buffer 301 to the reference frame buffer 303. However, it will be appreciated that in other embodiments, the reference frame may be generated in other ways. For example, the reference frame may be generated by a local decoding of a previously encoded frame thereby providing a reference frame which corresponds closely to the reference frame which is generated at a receiving video decoder.

The reference frame buffer 303 is coupled to a segmentation processor 305 which is operable to segment the reference frame into a plurality of picture elements. A picture element corresponds to a group of pixels selected in accordance with a given selection criterion and in the described embodiment, each picture element corresponds to an image segment determined by the segmentation processor 305. In other embodiments, picture elements may alternatively or additionally correspond to encoding blocks such as a DCT transform block or a predefined (macro) blocks.

In the described embodiment image segmentation seeks to group pixels together into image segments which have similar movement characteristics, for example because they belong to the same underlying object. A basic assumption is that object edges cause a sharp change of brightness or colour in the image. Pixels with similar brightness and/or colour are therefore grouped together resulting in brightness/colour edges between regions.

In the preferred embodiment, picture segmentation thus comprises the process of a spatial grouping of pixels based on a common property. There exist several approaches to picture- and video segmentation, and the effectiveness of each will generally depend on the application. It will be appreciated that any known method or algorithm for segmentation of a picture may be used without detracting from the invention.

In the preferred embodiment, the segmentation includes detecting disjoint regions of the image in response to a common characteristic and subsequently tracking this object from one image or picture to the next.

In one embodiment, the segmentation comprises grouping picture elements having similar brightness levels in the same image segment. Contiguous groups of picture elements having similar brightness levels tend to belong to the same underlying object. Similarly, contiguous groups of picture elements having similar colour levels also tend to belong to the same underlying object and the segmentation may alternatively or additionally comprise grouping picture elements having similar colours in the same segment.

The following description will for brevity and clarity focus on the processing of a single segment, henceforth denoted the first segment, but it will be appreciated that the video encoder is preferably capable of generating and processing a plurality of picture elements for a given frame.

The segmentation processor 305 is coupled to an offset processor 307 which generates a plurality of offset picture elements with different sub-pixel offsets for the first segment. The offset processor 307 preferably generates one offset segment which has a zero offset, i.e. the unmodified first segment is preferably one of the plurality of offset segments. In addition, the offset processor 307 preferably generates a number of offset pictures which have equidistant offsets. For example, if four offset segments are generated, the offset processor 307 preferably generates a segment having an offset of (x,y)=(0,0), another segment having an offset of (x,y)=(0.5,0), a third segment having an offset of (x,y)=(0,0.5) and a fourth segment having an offset of (x,y)=(0.5,0.5). Thus, in the example, four offset segments are generated corresponding to a sub-pixel accuracy or granularity of 0.5 pixels.

The offset processor 307 is coupled to a scan processor 309 which receives the offset segments. The scan processor 309 is further coupled to the first frame buffer 301 and searches the first frame for a matching image segment for each of the offset segments.

Specifically, the scan processor 309 may determine a distance or difference parameter given by:

$$D ( S ) = {\sum }_{Δ x , Δ y ∈ S} {( S ( Δ x , Δ y ) - P ( Δ x + x , Δ y + y ) )}^{2}$$

where S denotes the offset segment, S(Δx,Δy) denotes the pixel at relative location (Δx,Δy) in the segment and P(a,b) denotes the pixel at location (a,b) in the first frame which is to be encoded.

The scan processor 309 searches by evaluating the distance parameter for all possible (x,y) values and determines the matching segment for the given offset segment as that having the lowest distance value. Furthermore, if the distance value is above a given threshold it may be determined that there is no matching segment and no motion compensation will be performed based on the first segment.

The scan processor 309 is coupled to a selection processor 311 which selects one of the offset segments corresponding to the required sub-pixel displacement. In the described embodiment, the selection processor 311 simply selects the offset segment which has the lowest distance parameter.

The selection processor 311 is coupled to a displacement data processor 313 which generates displacement data for the first segment. In the described embodiment, the displacement data processor 313 generates a motion vector for the first segment where the motion vector has a sub-pixel displacement part indicative of the selected offset picture element and integer pixel displacement part indicating the integer pixel offset between the first segment and the matching segment. Specifically, the motion vector may be generated as (xₘ,yₘ) if the (0,0) offset segment was selected, (xₘ+0.5,yₘ) if the (0=0.5,0) offset segment was selected, (xₘ,yₘ+0.5) if the (0,0.5) offset segment was selected and (xₘ+0.5,yₘ+0.5) if the (0.5,0.5) offset segment was selected where xₘ,yₘ are the integer values of x and y of the distance parameter calculation for the matching image segment.

The displacement data processor 313 is furthermore coupled to the offset processor 307 and receives the selected offset segment from there. The displacement data processor 313 is also coupled to an encoding unit 315 which encodes the first frame. In particular, the matching segment of the first frame is encoded relative to the selected offset segment.

In the described embodiment, the encoding unit 315 generates relative pixel values by subtracting the pixel values of the selected offset segment from the matching segment. The resulting relative frame is consequently encoded using spatial frequency transforms, quantization and encoding as is well known in the art. As the values of the pixel data of the first segment (and other processed segments) are significantly reduced, a significant reduction in the data size can be achieved.

The encoding unit 315 is coupled to an output processor 317 which is further coupled to the displacement data processor 313. The output processor 317 generates an output data stream from the video encoder 300. The output processor 317 specifically combines encoding data for a the frames of the video signal, auxiliary data, control information etc as required for the specific video encoding protocol. In addition, the output processor 317 includes the displacement data in the form of motion vectors having both a fractional and integer part where the fractional part indicates the selected offset picture, and thus the selected sub-pixel interpolation, and the integer part indicates the shift in the first frame of the interpolated segment. However, in the described embodiment, the output processor 317 does not include any specific segmentation data defining the location or dimensions of the detected image segments.

The video encoder thus provides a shift motion estimation encoding wherein segments of a reference frame are used to compensate a first (future) frame. Hence, displacement and inclusion of the first segment in the first frame may be performed before or during the decoding of this. Hence, the video encoder provides a signal that does not require pre-knowledge of the location or dimension of segments for decoding the first frame. Furthermore, a very efficient and high quality signal is generated as sub-pixel motion compensation is performed.

The video encoder thus provides for improved quality to data size ratio while allowing a low complexity implementation.

FIG. 4 is an illustration of shift motion estimation video decoder 400 in accordance with an embodiment of the invention. In the described embodiment, the video decoder 400 receives the video signal generated by the video encoder 300 of FIG. 3 and decodes this.

The video decoder 400 comprises a receive frame buffer 401 which receives the video frames of the video signal. The video decoder further comprises a decoded reference frame buffer 403 which stores a reference frame used to decode a predicted frame of the video signal. The decoded reference frame buffer 403 is coupled to the output of the video encoder and the decoded reference frame buffer 403 receives the appropriate reference frames in accordance with the requirements of the implemented coding protocol as will be appreciated by the person skilled in the art.

The operation of the video decoder will be described with specific reference to the situation wherein the decoded reference frame buffer 403 contains the decoded reference frame corresponding to the reference frame described with respect to the operation of the video encoder 300 and the receive frame buffer 401 comprises a predicted frame corresponding to the first frame described with respect to the operation of the video encoder 300. Thus, the decoded reference frame buffer 403 comprises the reference frame used to encode the predicted frame and will accordingly be used to decode this. Furthermore, the received video signal comprises non-integer motion vectors referenced to image segments of the reference frame. However, in the described embodiment the video signal comprises no information related to the dimension of the segments of the predicted frame or of the reference frame. Hence, decoding is preferably not based on identification of image segments in the predicted frame, which has not been decoded yet and therefore is not suitable for image segmentation. However, the shift motion estimation and compensation provides for segment based motion compensation based on the reference frame stored in the decoded reference frame buffer 403.

Accordingly, the decoded reference frame buffer 403 is coupled to a receive segmentation processor 405 which performs image segmentation on the decoded reference frame. The segmentation algorithm is equivalent to the segmentation processor 305 of the video encoder 300 and therefore identifies the same segments (or predominantly the same segments). Thus, the video encoder 300 and video encoder 400 independently generate substantially the same image segments by individual segmentation processes. It will be appreciated that preferably all image segments identified by the encoder are also identified by the decoder but that this is not essential for the operation.

It will further be appreciated that any suitable functionality or protocol for associating one or more image segments used for the encoding with one or more image segments generated by the receive segmentation processor 405 may be used.

As a specific example, the video encoder 300 may include a location identification for each motion vector corresponding to a centre point for the detected image segment to which the motion vector relates. When receiving the data, the video decoder may associate the motion vector with the image segment determined by the receive segmentation processor 405 that comprises this location. Thus, the association between corresponding image segments independently determined in the video encoder and video decoder may be achieved without any information exchange related to the characteristics or dimensions of the image segments. This provides for a significantly reduced data rate.

The following description will for brevity and clarity focus on the processing of a first segment identified by the receive segmentation processor 405 but it will be appreciated that the video decoder is preferable capable of generating and processing a plurality of picture elements for a given frame.

The receive segmentation processor 405 is coupled to a receive interpolator 407 which interpolates the first image segment in the reference frame to generate a sub-pixel offset segment corresponding to the offset segment that was selected by the video encoder 300.

The receive interpolator 407 is coupled to a displacement data extractor 409 which is further coupled to the receive frame buffer 401. The displacement data extractor 409 extracts the displacement data from the received video signal. It furthermore splits the displacement data into a sub-pixel part and an integer pixel part and feeds the sub-pixel part to the receive interpolator 407.

In the described embodiment, the displacement data extractor 409 receives a motion vector for the first segment and passes the fractional part to the displacement data extractor 409. In response, the displacement data extractor 409 performs an interpolation in the reference frame corresponding to the interpolation performed for the first segment in the video encoder for the selected offset segment. Thus, the receive interpolator 407 generates an image segment directly corresponding to the selected offset segment of the video decoder. The image segment has a sub-pixel accuracy thereby providing for a decoded signal of higher quality.

The video encoder furthermore comprises a shift processor 411 which determines a location of the generated offset segment in the predicted frame in response to the integer pixel part of the displacement data. Specifically, the shift processor 411 is coupled to the receive interpolator 407 and the displacement data extractor 409 and receives the interpolated segment from the receive interpolator 407 and the integer part of the motion vector for the segment from the displacement data extractor 409. The shift processor 411 moves the offset picture element in the reference system of the predicted frame, i.e. it may generate a motion compensation frame wherein the operation:
p(x+Int[x_{MV}],y+Int[y_{MV}])=sₒ(x,y)
for all pixels in the offset segment; where p(x,y) is a pixel element at location x,y in the predicted frame, sₒ(x,y) is the pixel element in the offset image segment at location x,y in the reference frame and (xₘᵥ,yₘᵥ) is the motion vector for the segment.

The video decoder 400 further comprises a decoding unit 413 which is coupled to the shift processor 411 and the receive frame buffer 401. The decoding unit 413 decodes the predicted frame using the motion compensation frame generated by the shift processor 411. Specifically, the first frame may be decoded as a relative image to which the motion compensation frame is added as is well known in the art. Thus, the decoding unit 413 generates a decoded video signal.

Hence in accordance with the described embodiment, a video encoding and decoding system is disclosed which uses shift motion estimation allowing segment based motion compensation with sub-pixel accuracy. Accordingly, a very efficient encoding may be achieved having a high quality to data size ratio.

Furthermore, the sub-pixel processing and offsetting/interpolation is performed in the reference frame prior to the integer shifting rather than in the predicted frame after integer shifting. Experiments have demonstrated that this results in a significantly improved performance.

The embodiment furthermore provides for a relatively low complexity implementation for example as a software program running on a suitable signal processor. Alternatively, the implementation may wholly or partly use dedicated hardware.

In general, the invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is no feasible and/or advantageous. In addition, singular references do not exclude a plurality. Thus references to “a”, “an”, “first”, “second” etc do not preclude a plurality.

1. A video encoder for encoding a video signal to generate video data; the video encoder comprising:
means for generating (307), for at least a first picture element in a reference frame, a plurality of offset picture elements having different sub-pixel offsets;
means for searching (309), for each of the plurality of offset picture elements, a first frame to find a matching picture element;
means for selecting (311) a first offset picture element of the plurality of offset picture elements;
means for generating displacement data (313) for the first picture element, the displacement data comprising sub-pixel displacement data indicative of the first offset picture element and integer pixel displacement data indicating an integer pixel offset between the first picture element and the matching picture element;
means for encoding (315) the matching picture element relative to the selected offset picture element; and
means for including (317) the displacement data in the video data.

2. A video encoder as claimed in claim 1 wherein the means for selecting (311) comprises means for determining a difference parameter between each of the plurality of offset picture elements and the matching picture element and means for selecting the first offset picture element as the offset picture element having the smallest difference parameter.

3. A video encoder as claimed in claim 1 further comprising means for generating the first picture element (305) by image segmentation of the reference frame.

4. A video encoder as claimed in claim 3 wherein the video encoder is configured not to include segment dimension data in the video data.

5. A video encoder as claimed in claim 1 wherein the video encoder is a block based video encoder and the first picture element is an encoding block.

6. A video encoder as claimed in claim 1 wherein the means for generating (307) the plurality of offset picture elements is operable to generate at least one offset picture element by pixel interpolation.

7. A video encoder as claimed in claim 1 wherein the displacement data is motion estimation data.

8. A video encoder as claimed in claim 7 wherein the displacement data is shift motion estimation data.

9. A video encoder as claimed in claim 1 wherein one offset picture element of the plurality of offset picture elements has an offset of substantially zero.

10. A video decoder for decoding a video signal, the video decoder comprising:
means for receiving (401) the video signal comprising at least a reference frame and a predicted frame and displacement data for a plurality of picture elements of the reference frame;
means for determining (405) a first picture element of the plurality of picture elements of the reference frame;
means for extracting displacement data (409) for the first picture element comprising first sub-pixel displacement data and first integer pixel displacement data;
means for generating a sub-pixel offset picture element (407) by offsetting the first picture element in response to the first sub-pixel displacement data;
means for determining a location (411) of a second picture element in the predicted frame in response to a location of the first picture element in the first image and the first integer pixel displacement data; and
means for decoding (413) the second picture element in response to the sub-pixel offset picture element.

11. A video decoder as claimed in claim 10 wherein the means for determining a first picture element (405) is operable to determine the first picture element by image segmentation of the first frame.

12. A video decoder as claimed in claim 11 wherein the video data comprise no segment dimension data.

13. A method of encoding a video signal to generate video data; the method comprising the steps of:
generating, for at least a first picture element in a reference frame, a plurality of offset picture elements having different sub-pixel offsets;
searching, for each of the plurality of offset picture elements, a first frame to find a matching picture element;
selecting a first offset picture element of the plurality of offset picture elements;
generating displacement data for the first picture element, the displacement data comprising sub-pixel displacement data indicative of the first offset picture element and integer pixel displacement data indicating an integer pixel offset between the first picture element and the matching picture element;
encoding the matching picture element relative to the selected offset picture element; and
including the displacement data in the video data.

14. A method of decoding a video signal, the method comprising the steps of:
receiving the video signal comprising at least a reference and a predicted frame and displacement data for a plurality of picture elements of the reference frame;
determining a first picture element of the plurality of picture elements of the reference frame;
extracting displacement data for the first picture element comprising first sub-pixel displacement data and first integer pixel displacement data;
generating a sub-pixel offset picture element by offsetting the first picture element in response to the first sub-pixel displacement data;
determining a location of a second picture element in the predicted frame in response to a location of the first picture element in the first image and the first integer pixel displacement data; and
decoding the second picture element in response to the sub-pixel offset picture element.

15. (canceled)

16. (canceled)
